(19) United States
(12) Patent Application Publication
(10) Pub. No.: US 2015/0242447 A1
(43) Pub. Date: Aug. 27, 2015

(54) IDENTIFYING EFFECTIVE CROWDSOURCE CONTRIBUTORS AND HIGH QUALITY CONTRIBUTIONS

(71) Applicant: GOOGLE INC., Mountain View, CA (US)

(72) Inventors: Panagiotis Grigorios Ipeirotis, New York, NY (US); Evgeniy Gabrilovich, Saratoga, CA (US); Chun How Tan, Mountain View, CA (US); Yevgeny E. Agichtein, Atlanta, GA (US)

(73) Assignee: GOOGLE INC., Mountain View, CA (US)

(21) Appl. No.: 14/244,674

(22) Filed: Apr. 3, 2014

(30) Foreign Application Priority Data
Feb. 21, 2014 (GR) 20140100091

(51) Int. Cl. G06F 17/30; G06Q 50/00; G06Q 30/02

(52) U.S. Cl. CPC G06F 17/30303; G06Q 30/0246; G06Q 50/01

(57) ABSTRACT

Systems and methods are disclosed for targeting effective contributors and identifying high quality contributions. For example, a method may include displaying an advertisement to a potential contributor via an advertising platform, receiving an indication that the potential contributor responded to the advertisement, generating a crowdsourcing exercise that is presented to the contributor, receiving a response (a conversion event) from the contributor to the crowdsourcing exercise, and notifying the advertising platform about the conversion event. As another example, a method may include determining a concept space for a new contribution, obtaining previously correct and incorrect contributions of the contributor in the concept space, and determining an expertise confidence score for the new contribution based on a comparison of the new contribution with the previously correct and incorrect contributions. The method may include automatically approving the new contribution for the crowdsourced repository based on the expertise confidence score.

### CROSS REFERENCE TO RELATED APPLICATION

This application claims priority under 35 U.S.C. §119 to foreign Application Serial No. 20140100091, entitled “IDENTIFYING EFFECTIVE CROWDSOURCE CONTRIBUTORS AND HIGH QUALITY CONTRIBUTIONS” filed on Feb. 21, 2014, in Greece. The subject matter of this earlier filed application is hereby incorporated by reference.

### BACKGROUND

Crowdsourcing has been an enabling mechanism behind the generation of many resources, such as WIKIPEDIA, FREEBASE, and other knowledge repositories. Crowdsourcing has also been used to generate useful image tags, transcribe letters, and generate translations. A crowdsourced repository is a repository with entries contributed by many different individual contributors. A crowdsourced repository can have thousands or even millions of different contributors. The contributors may be self-motivated or compensated. Crowdsourcing works best when the contributors are self-motivated and knowledgeable about their contributions. Recruiting contributors via monetary rewards, for example via Amazon's MECHANICAL TURK, can result in some lower-quality contributions, as the contributors are motivated by quantity and not quality, and may be motivated to contribute in areas in which they have little experience just to earn extra money.

To maintain high levels of accuracy in the crowdsourced repository, some new contributions may be given a pending status. In some systems, pending contributions may be manually reviewed prior to being allowed to go active (or live). In other words, contributions may be put in a pending or holding queue and not available to the general public until after a moderator has reviewed and released the contribution. This delays the addition of valid contributions and can form a bottleneck. In some systems, contributions may be made live upon submission and reviewed at a later time, or marked as pending or unverified until a period of time has passed without the contribution being marked as incorrect or disputed. This approach, however, allows introduction of erroneous facts into the repository, even if for a limited time.

### SUMMARY

Disclosed systems and methods target and attract crowdsourcing contributors who have suitable expertise for a specific task by using existing Internet advertising platforms with a feedback loop to refine the advertising campaign. In one implementation, contributors who respond to ads and participate in the crowdsourcing exercise (e.g., answer questions designed to evaluate expertise or gather new knowledge) are reported to the advertising platform as conversion events—meaning that not only did the contributor click on the ad, but they also participated in the exercise. The advertising system can use this feedback to increase the contribution yield of the advertising campaign, and not just increasing the number of clicks. In some implementations a value may be provided with the contribution event to the advertising platform. The value may be an indication of the competence and desirability of the contributor and may be used to further refine the advertising campaign to target other suitable contributors. Disclosed systems and methods also predict a contribution quality for a new contribution to identify new contributions that can be automatically added to the active or live portion of the crowdsourced repository. The prediction allows the system to automatically approve contributions having a high predicted quality without the need to subject them to a secondary review or wait some predetermined period. The prediction quality may be measured based on several signals, such as user contribution history, the difficulty for the type of contribution, and the contributor's expertise in the subject area.

In one aspect, a computer system includes at least one processor, and memory storing instructions that, when executed by the at least one processor, cause the system to determine a concept space for a new contribution from a contributor to a crowdsourced repository, obtain previously correct contributions of the contributor in the concept space, obtain previously incorrect contributions of the contributor in the concept space, and determine an expertise confidence score for the new contribution based on a comparison of the new contribution with the previously correct contributions and the previously incorrect contributions. The instructions may also include instructions that, when executed, cause the system to automatically approve the new contribution for the crowdsourced repository based on whether a threshold is met based on the expertise confidence score.

These and other aspects can include one or more of the following features. For example, the memory may further store instructions that, when executed by the at least one processor, cause the system to: determine a type of the new contribution, determine a level of difficulty assigned to the type, and determine a difficulty confidence score based on the level of difficulty. In such an implementation, automatically approving the new contribution may be based on whether the threshold is met based on a combination of the difficulty confidence score and the expertise confidence score. As another example, the concept space may be a topic in a taxonomy of commercial topics, a type of the new contribution, and/or the crowdsourced repository may be a knowledge base and the new contribution is a triple for the knowledge base. In some implementations, the concept space may be determined by obtaining a text equivalent for each element of the triple, generating a pseudo document from the text equivalents, and classifying the pseudo document into the taxonomy.

As another example, the expertise confidence score is a first expertise confidence score and the memory further stores instructions that, when executed by the at least one processor, cause the system to determine a second concept space for the new contribution, obtain previously correct contributions of the contributor in the second concept space, obtain previously incorrect contributions of the contributor in the second concept space, and determine a second expertise confidence score for the new contribution based on a comparison of the new contribution with the previously correct contributions for the second concept space and with the previously incorrect contributions for the second concept space. In such implementations, automatically approving the new contribution is based on whether the threshold is met based on a combination of the first expertise score and the second expertise score. In some implementations, the second concept space is a type of the new contribution and the first concept space may be a topic in a taxonomy, the crowdsourced repository may be a knowledge base and the new contribution may be a triple that includes a subject, a predicate, and an object, where the type is determined by the predicate.

As another example, comparing the new contribution with the previously correct contributions and the previously incorrect contributions may be based on one or more of a dot product, a cosine similarity, a number of intersecting concepts, and a Jaccard Index. As another example, in response to the new contribution being automatically approved, the instructions may include instructions that cause the computing system to add the new contribution to the previously correct contributions of the contributor.

In another aspect, a method includes determining, using at least one processor formed in a substrate, a contribution type for a new contribution from a contributor to a crowdsourced repository, obtaining a first positive feature set of prior correct contributions from the contributor for the contribution type, obtaining a first negative feature set of prior incorrect contributions from the contributor for the contribution type, and determining, using the at least one processor, a first expertise confidence score for the new contribution based on a comparison of the new contribution with the first positive feature set and the first negative feature set. The method may also include determining a taxonomy classification for the new contribution, obtaining a second positive feature set of prior correct contributions from the contributor for the taxonomy classification, obtaining a second negative feature set of prior incorrect contributions from the contributor for the taxonomy classification, and determining, using the at least one processor, a second expertise confidence score for the new contribution based on a comparison of the new contribution with the second positive feature set and with the second negative feature set. The method may further include determining a contribution confidence score based on a combination of the first expertise confidence score and the second expertise confidence score and automatically adding the new contribution to active contributions for the crowdsourced repository based on whether the contribution confidence score meets a threshold.

These and other aspects can include one or more of the following features. For example, the crowdsourced repository may be a knowledge base and the new contribution is a triple for the knowledge base. In such an implementation, determining the taxonomy classification can include obtaining a text equivalent for each element of the triple, generating a pseudo document from the text equivalents, and classifying the pseudo document into the taxonomy. As another example, the method may include determining a contributor confidence score based on prior contributions by the contributor, and determining the contribution confidence score based on a combination of the contributor confidence score, the first expertise confidence score and the second expertise confidence score.

As another example, the method may include determining a type of the new contribution, determining a level of difficulty assigned to the type, determining a difficulty confidence score based on the level of difficulty, and determining the contribution confidence score based on a combination of the difficulty confidence score, the first expertise confidence score and the second expertise confidence score. In some such implementations, the type may be based on an organizational structure of the crowdsourced repository.

In another aspect, a method includes providing information to an advertising platform, the advertising platform using the information to determine potential contributors for a crowdsourced repository and to display an advertisement to the potential contributors. The method also includes receiving, using at least one processor formed in a substrate, an indication that a contributor of the potential contributors responded to the advertisement, generating, using the at least one processor, a crowdsourcing exercise that is presented to the contributor, and determining that a conversion event occurred for the contributor in response to receiving a response from the contributor to the crowdsourcing exercise. The method may also include notifying the advertising platform that the conversion event occurred for the contributor.

These and other aspects can include one or more of the following features. For example, the method may also include calculating a value for the conversion event based on one or more responses to the crowdsourcing exercise from the contributor, and providing the value to the advertising platform with the notification, the advertising platform using the value to refine the determining of potential contributors. In some implementations, the crowdsourcing exercise has a question format, where the question is either a collection question or a calibration question. In such implementations the method may also include repeating the generating and receiving, thereby collecting a quantity of responses for the contributor; and storing the responses for the contributor and whether a particular response was a collection or a calibration question. The value may be based on an information gain for a most recent response from the contributor multiplied by the quantity of responses and the information gain may be based on calculating a probability of a correct response in a binomial distribution, a quantity of correct responses, and a quantity of incorrect responses. As another example, the value is provided to the advertising platform when the value meets a threshold.

In another aspect, a non-transitory computer-readable medium may include instructions executable by at least one processor that cause a computer system to perform one or more of the methods described above.

One or more of the implementations of the subject matter described herein can be implemented so as to realize one or more of the following advantages. As one example, implementations attract unpaid contributors, targeting those with expertise in specific topics. Implementations also automatically optimize the ad campaign by quantifying the behavior of the contributors who clicked on the ad and sending the advertising system feedback about contributors considered valuable, effectively asking the advertising system to optimize for maximizing the contribution yield and not just the number of clicks. Targeting advertising using the feedback can result in three times more conversion events. Furthermore, the contributors arriving via targeted ads provide nine times more contributions than non-targeted advertising campaigns (e.g., general ads without conversion event feedback). Targeted advertising thus maximizes the usefulness of the advertising campaign and the advertising dollars spent. Implementations may further provide feedback that causes the advertising system to optimize for competent contributors, e.g., contributors willing to participate in the crowdsourcing exercise and possessing the relevant knowledge. This ensures the targeted contributors provide higher quality contributions, further maximizing advertising dollars spent.

Predicting the quality of a contribution provides the advantage of minimizing the introduction of erroneous contributions without delaying the inclusion of valid contributions. Thus, the introduction of new facts to a crowdsourced repository is accelerated without adversely affecting the quality of the repository. The use of several signals to predict the quality of a particular contribution can reach 92.5% precision (fraction of predicted valid contributions that are in fact valid) at 50% recall (fraction of all valid contributions), significantly out performing past contributor history alone.

The details of one or more implementations are set forth in the accompanying drawings and the description below. Other features will be apparent from the description and drawings, and from the claims.

### BRIEF DESCRIPTION OF DRAWINGS

FIG. 1 illustrates an example system in accordance with the disclosed subject matter.

FIG. 2 illustrates a flow diagram of an example process for providing feedback to an advertising platform to attract crowdsource contributors willing to participate and having relevant knowledge.

FIG. 3 illustrates an example advertisement used in an advertising campaign to attract crowdsource contributors having relevant knowledge, in accordance with an implementation.

FIG. 4 illustrates a user interface for an example crowdsourcing exercise.

FIG. 5 illustrates a flow diagram of an example process for predicting the quality a contribution, in accordance with an implementation.

FIG. 6 illustrates a flow diagram of an example process for determining the classification of a contribution, according to an implementation.

FIG. 7 shows an example of a computer device that can be used to implement the described techniques.

FIG. 8 shows an example of a distributed computer device that can be used to implement the described techniques.

Like reference symbols in the various drawings indicate like elements.

### DETAILED DESCRIPTION

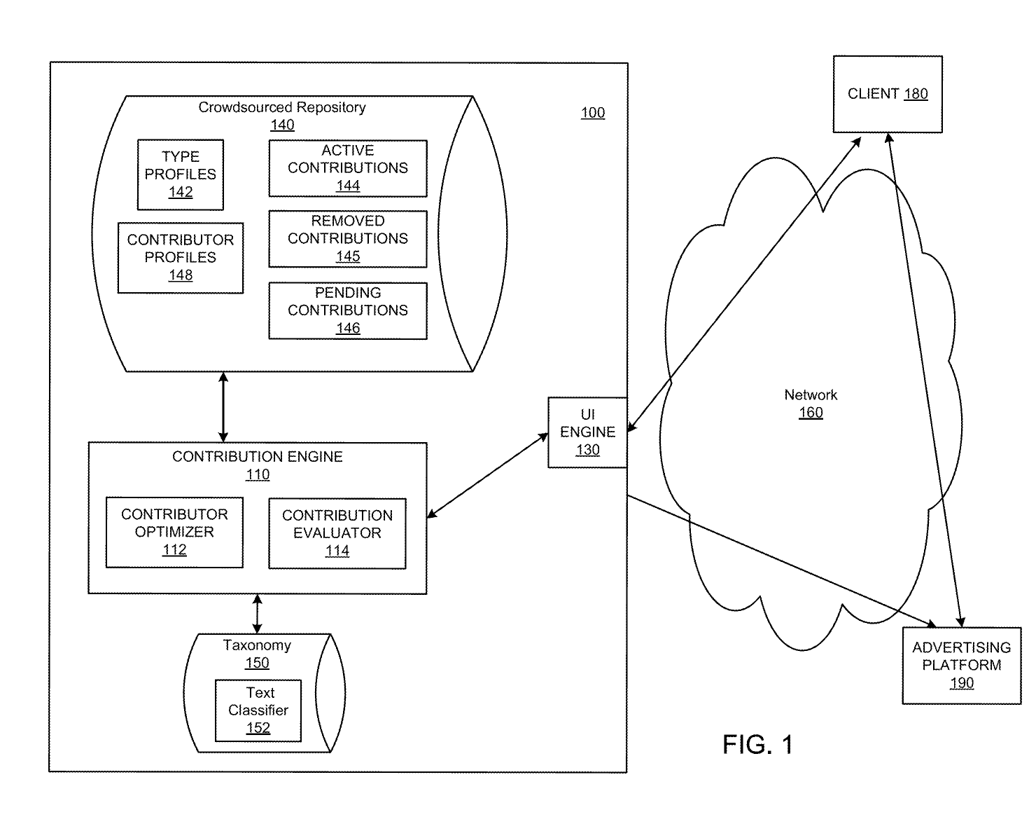

FIG. 1 is a block diagram of a crowdsource targeting system in accordance with an example implementation. The system 100 may be used to identify and attract contributors with relevant knowledge and to automatically add contributions to the crowdsourced repository that the system predicts to be of sufficient quality. In some implementations, the system 100 can quantify the usefulness of a contributor and provide feedback to an advertising platform regarding useful contributors, so that the advertising platform can optimize the advertising campaign to identify additional useful contributors. In some implementations, the system 100 can predict the quality of a contribution based on a variety of signals for the contribution, including attributes of the subject matter contributed and the contributor's historical contributions with regard to the subject matter. While system 100 in FIG. 1 is described as a crowdsourced knowledge base, other configurations and applications may be used. For example, the system may be used in any crowdsourced task, including image recognition, translations, article contributions, or any other crowdsourced problem.

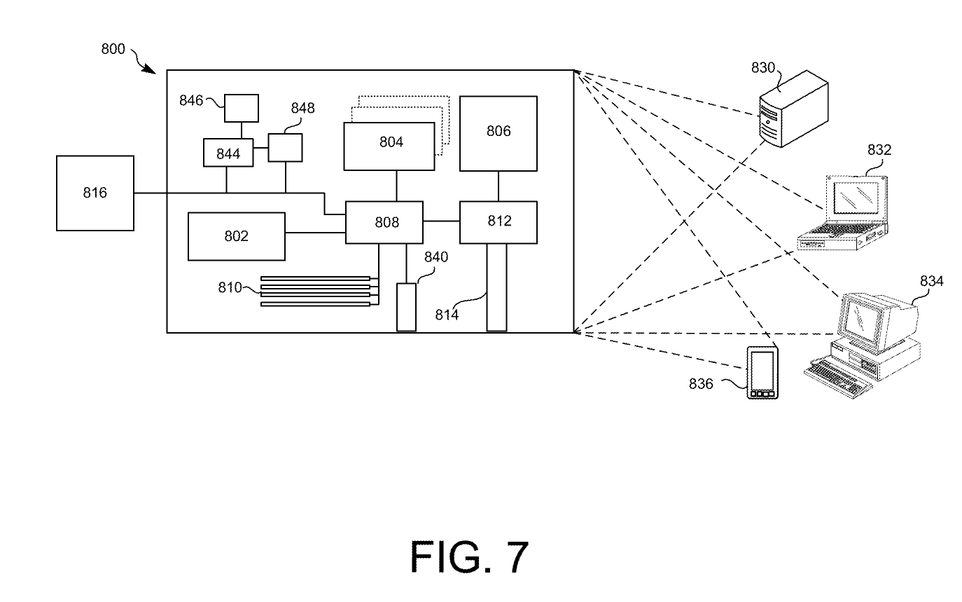

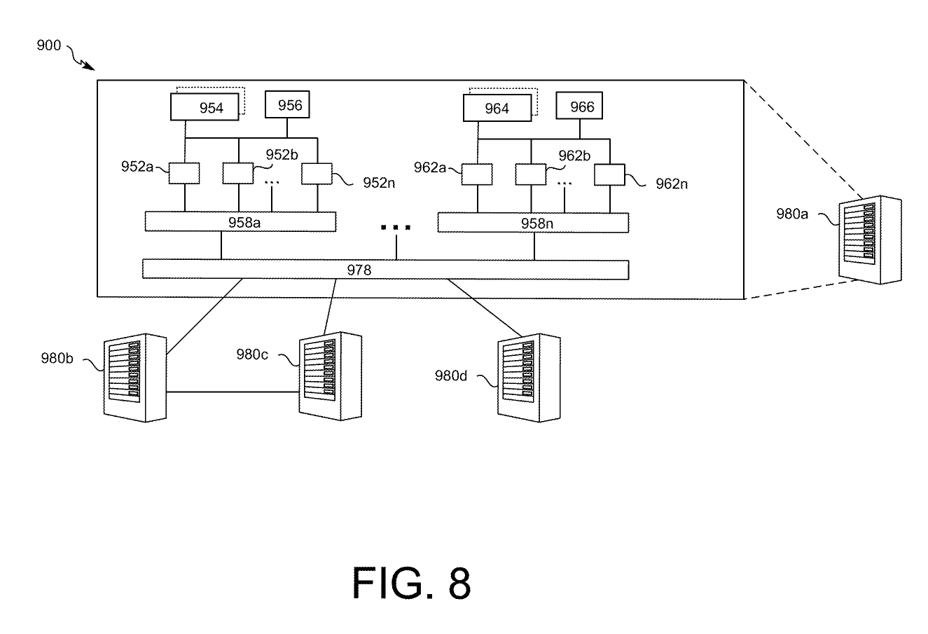

The crowdsource targeting system 100 may be a computing device or devices that take the form of a number of different devices. For example the system 100 may be a standard server, a group of such servers, a client-server system, or a rack server system. In addition, system 100 may be implemented in a personal computer, for example a laptop computer. The crowdsource targeting system 100 may be an example of computer device 700, as depicted in FIG. 7, or computer device 800, as depicted in FIG. 8.

The crowdsource targeting system 100 may include a crowdsourced repository 140. In some implementations, the crowdsourced repository 140 may be a knowledge base, stored as a directed edge-labeled graph. Such a graph stores nodes and edges. The nodes in the data graph represent an entity, such as a person, place, item, idea, topic, abstract concept, concrete element, other suitable thing, or any combination of these. Entities in the data graph may be related to each other by edges, which represent relationships between entities. For example, the data graph may have an entity that corresponds to the musician George Harrison and the data graph may have an albums relationship between the George Harrison entity and entities representing albums that George Harrison has released. The graph may also store attributes of entities. The nodes, attributes, and relationships may represent facts. In some implementations, the facts may be stored in a <subject,predicate,object> format, where the subject and object are entities or attributes in the graph and the predicate is the link between the subject and object. In some implementations, the crowdsourced repository 140 can be a database with contributed records, an image repository with contributed labels, an entertainment repository with contributed reviews or opinions, a translation dictionary with contributed entries, etc., and crowdsourced repository is not limited to a knowledge base. In some implementations, the crowdsourced repository 140 may be stored in an external storage device accessible from system 100. In some implementations, the crowdsourced repository 140 may be distributed across multiple storage devices and/or multiple computing devices, for example multiple servers.

In some implementations, the crowdsourced repository 140 may include active contributions 144, removed contributions 145, and pending contributions 146. The active contributions 144 may be contributions that are live, in other words the contributions are available to the public and do not include a flag indicating the contribution is considered unverified. The removed contributions 145 may be contributions that a moderator or other contributor has deemed invalid or false. Such contributions may not be visible to the general public but may be kept to generate statistics for the type of contribution and/or for the contributor. In some implementations a moderator may “undelete” a removed contribution, e.g., by making it active again. Such an action indicates an incorrect deletion performed by a contributor. Pending contributions 146 may be contributions that have yet to be verified. In some implementations, the pending contributions 146 may be available to the public, but with some indication that the contribution is not verified. In some implementations, pending contributions 146 are not available to the public. The active contributions 144, removed contributions 145, and pending contributions 146 may be stored in separate repositories, separate computers, and/or separate tables on the same computer.

The crowdsourced repository 140 may also include type profiles 142. Contributions in the crowdsourced repository 140 may have a type. For example, in a knowledge base the predicate of a contribution may determine the type of the contribution. In some implementations, the crowdsourced repository 140 may store a profile for each type, for example the total number of contributions of the type, the total number of deleted or removed contributions for the type, etc. In some implementations, such statistics may be generated or calculated on-the-fly (e.g., at the time they are requested). Crowdsourced repository 140 may also include contributor profiles 148. Contributor profiles 148 may store historical statistics for a contributor, such as the total number of prior contributions, total number of correct prior contributions, total number of incorrect (e.g., removed) prior contributions, total number of incorrectly deleted contributions, membership lifetime, time of the last contribution, etc. Certain data may be treated in one or more ways before it is stored or used, so that personally identifiable information is removed. For example, a contributor's identity may be treated so that no personally identifiable information can be determined for the contributor, or a contributor's geographic location may be generalized where location information is obtained (such as to a city, ZIP code, or state level), so that a particular location of a contributor cannot be determined.

Although not shown in FIG. 1, the crowdsource targeting system 100 can include one or more processors (e.g., hardware processors formed in a substrate) configured to execute one or more machine executable instructions or pieces of software, firmware, or a combination thereof. The crowdsource targeting system 100 can also include an operating system and one or more computer memories, for example, a main memory, configured to store one or more pieces of data, either temporarily, permanently, semi-permanently, or a combination thereof. The memory may include any type of storage device that stores information in a format that can be read and/or executed by the one or more processors. The memory may include volatile memory, non-volatile memory, or a combination thereof, and store modules that, when executed by the one or more processors, perform certain operations. In some implementations, the modules may be stored in an external storage device and loaded into the memory of system 100.

The modules may include a contribution engine 110 and a User Interface (UI) engine 130. The contribution engine 110 may include a contributor optimizer 112 and a contribution evaluator 114. In some implementations the contributor optimizer 112 and the contribution evaluator 114 may be on separate computing devices, so that the contribution engine 110 is distributed across multiple computing devices. The contributor optimizer 112 may monitor and evaluate contributors who participate in crowdsourcing exercises and provide feedback to an advertising platform 190 about valuable contributors, allowing the advertising platform 190 to optimize an advertising campaign to attract additional valuable participants. Contribution evaluator 114 may predict the quality of a new contribution based on a variety of signals, as explained herein. When the contribution quality meets a threshold, the contribution engine 110 may add the new contribution automatically to the active contributions 144. Otherwise, the contribution engine 110 may add the new contribution to pending contributions 146 for manual verification or test-of-time verification, etc. Manual verification includes having one or more experts or trusted contributors review the contributions prior to releasing the contribution to the active contributions. Test-of-time verification allows users of the crowdsourced repository to scrutinize the pending contributions 146 and identify those considered incorrect. If a contribution survives a set period of time without being identified as incorrect, the contribution is considered correct and moved to the active contributions 144.

The crowdsource targeting system 100 may also include a taxonomy 150. The taxonomy may be a hierarchical arrangement of topics or categories, with each topic/category being a node in the hierarchy. For example, a hierarchical taxonomy may have a top-level node of “Computers” and three sub-nodes within “Computers,” namely “Computers/Hardware”, “Computers/Software”, “Computers/Chat.” Each sub-node may also have additional sub-nodes, for example “Computers/Hardware/Printers” and “Computers/Hardware/Displays,” etc. Of course, the taxonomy may have more than one top-level category, and each top-level node may have one or more levels of sub-nodes. The taxonomy 150 may also include a hierarchical text classifier that analyzes text and classifies the text into one or more nodes of the taxonomy, as is known. For example, hierarchical classification is described in Dumais et al., “Hierarchical classification of web content,” SIGIR '00, pages 256-263, 2000, Koller et al., “Hierarchically classifying documents using very few words,” ICML, pages 170-178, 1997, and Ruiz et al., “Hierarchical text categorization using neural networks,” Information Retrieval, 5:87, 2002, all of which are incorporated herein by reference. The taxonomy 150 may also be a non-hierarchical taxonomy, such as a list of topics or other organization, and a corresponding text classifier.

The crowdsource targeting system 100 may also include UI engine 130. UI engine 130 may format information from contribution engine 110, for example a crowdsource exercise designed to either test expertise (e.g., a calibration exercise) or collect a contribution (e.g., a collection exercise) for the crowdsource repository, to a contributor. The UI engine 130 may also receive input from the contributor and provide the input to the contribution engine 110. The contributor may be remote, for example using client 180. Crowdsource targeting system 100 may be in communication with one or more clients 180 over network 160. Clients 180 may be a personal computing device, such as a tablet, smartphone, laptop, personal computer, etc., that allows a contributor to connect to the Internet and participate in a crowdsource exercise. In some implementations, one or more clients 180 may be used to interact directly with the contribution engine 110 for maintenance or reporting purposes. Network 160 may be, for example, the Internet, or the network 160 can be a wired or wireless local area network (LAN), wide area network (WAN), etc., implemented using, for example, gateway devices, bridges, switches, and/or so forth. Via the network 160, the crowdsource targeting system 100 may communicate with and transmit data to/from clients 180.

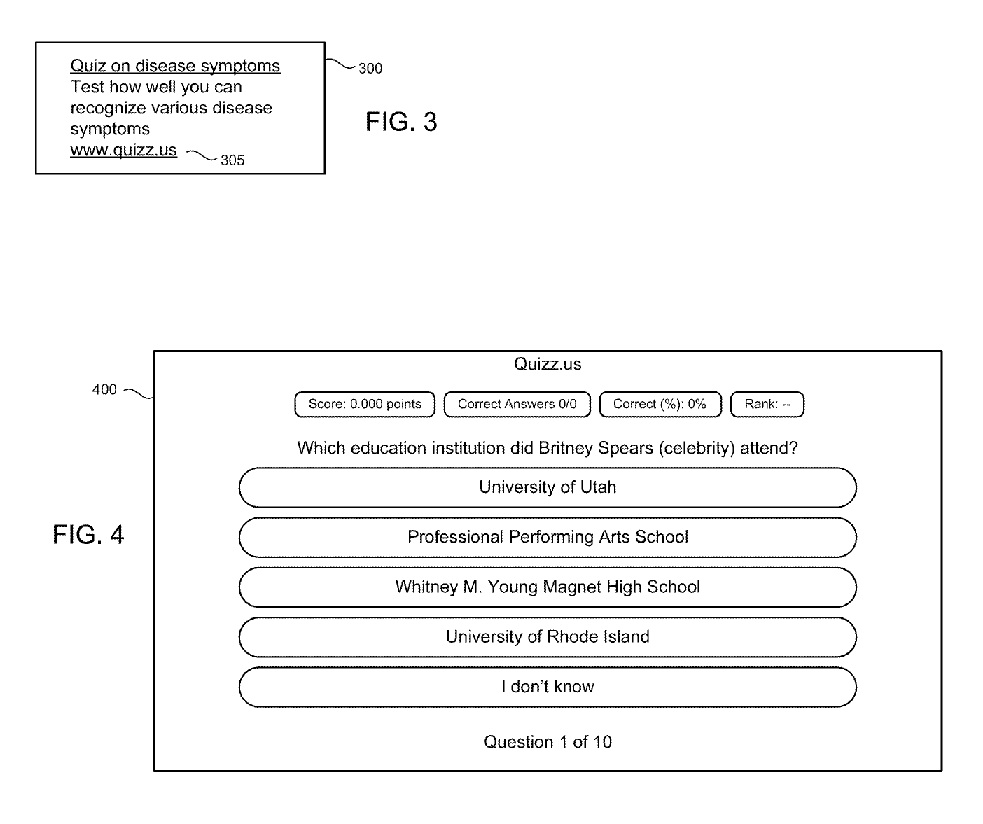

In some implementations, the UI engine 130 may also provide feedback to an advertising platform 190 via network 160. The advertising platform 190 may be any of existing or later created Internet advertising platforms, for example Google's ADWORDS or ADSENSE, Microsoft ADCENTER, Yahoo Advertising, Facebook Advertising, etc. Advertising platforms set up advertising campaigns according to the specification of the requestor. An advertising campaign may be based on keywords and may display an advertisement with search results for a query that relates to the keywords. An advertiser may also select ads displayed on certain websites, or certain pages within the websites. The advertising platform 190 may also provide other methods of deciding when to display an advertisement and what format the advertisement will have. FIG. 3 illustrates one example of an advertisement 300 that can be used to target prospective contributors. The advertisement 300 may be displayed on certain web pages, and/or may be displayed to a prospective contributor in response to a search that uses specified keywords. The text of the advertisement may include a description related to a specific subject area, e.g., medical knowledge, to further target potential contributors with particular expertise. The advertisement may include a link 305 to the crowdsource targeting system 100. Once a potential contributor selects link 305, the contributor may be directed to a crowdsourcing exercise provided by the crowdsourcing targeting system 100. FIG. 4 illustrates one example of a crowdsourcing exercise. In the example of FIG. 4, the exercise may be in the form of a quiz that tests the knowledge of the potential contributor or may be in the form of a question that collects or verifies new contributions for the crowdsource repository 140.

Advertising platforms have improved their targeting capabilities to identify users who are good matches for the goals of the advertiser. Often, advertising platforms optimize for clicks—in other words they determine characteristics of users who clicked on the advertisement and use the characteristics to target other users with similar characteristics. However, a user who clicks on the advertisement 300 of FIG. 3 but does not participate in the crowdsourcing exercise is wasting advertising system budget. Thus, the contribution engine may provide feedback to the advertising platform 190 when a potential contributor not only clicks on the advertisement but also completes at least one exercise. This is a conversion event, and when the advertising platform receives feedback about the conversion event, the platform can target users that will not only click on the ad but also contribute to the crowdsourced repository. In some implementations, as described herein, the crowdsource targeting system 100 may also provide a value that quantifies the quality and quantity of contributions by a contributor who clicked on the advertisement. Quantifying the value of a conversion event helps the advertising platform 190 to further optimize the advertising campaign to target contributors with relevant knowledge, which improves the quality of the contributions.

In some implementations, crowdsource targeting system 100 may be in communication with or include other computing devices that provide updates to the crowdsource repository 140 and/or taxonomy 150, for example from expert users, moderators, or system administrators. The crowdsource targeting system 100 of FIG. 1 represents one example configuration and implementations may incorporate other configurations. For example, some implementations may combine one or more of the contribution engine 110, the UI engine 130, and the text classifier 152 into a single module or engine. As another example, elements of the crowdsourced repository 140, contribution engine 110, contributor optimizer 112, contribution evaluator 114, etc. may be distributed across different computing devices. For example, elements of the crowdsourced repository 140 may be distributed across a client computing device and one or more servers that store the contributions and profiles.

Targeting High Quality Contributors

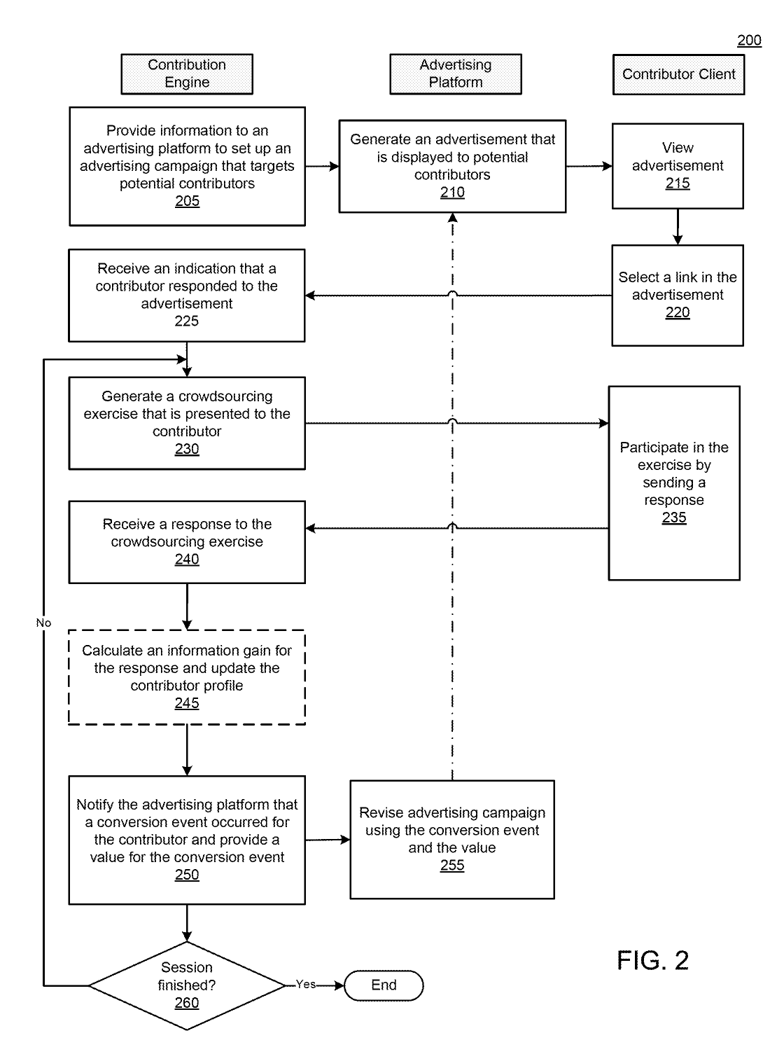

FIG. 2 illustrates a flow diagram of an example process 200 for providing feedback to an advertising platform to attract crowdsource contributors willing to participate and having relevant knowledge, in accordance with an implementation. Process 200 may be performed by a contribution engine, in conjunction with an Internet advertising platform and a contributor, for example as illustrated in system 100 of FIG. 1. Process 200 may begin with administrators of the crowdsourced repository setting up an advertising campaign with an Internet advertising platform (205). The administrators may provide information to the advertising platform, for example key words or display sites, through an existing interface provided by the advertising platform. The information may also include the format/text of the advertisement. The text may be further designed to appeal to contributors with relevant knowledge. The advertising platform may use the information to generate an advertisement that is displayed to a potential contributor (210) in the usual manner used by the advertising platform. A potential contributor may be using a client (e.g., client 180) to view the advertisement (215).

If the potential contributor decides to click on the advertisement (220), the potential contributor may be redirected to a user interface for the contribution engine. The contribution engine may receive an indication that the potential contributor arrived via the advertising campaign (225). This may be due to the link used in the advertisement, for example, or looking at the referral of the http request, as some advertising platforms will annotate the referral. The contribution engine may generate a crowdsourcing exercise for the potential contributor (230). The exercise may be in the form of a quiz question that can either collect new information (e.g., a new contribution) for the crowdsourced repository or test the competence of the contributor with regard to a topic (e.g., a calibration question where the answer is known). FIG. 4 illustrates one example of a crowdsourcing exercise. Of course other formats may be used in the crowdsourcing exercise. If the user participates in the exercise by providing a response (235), the contribution engine may receive the response (240) and consider the response to be a conversion event. A conversion event occurs when a potential contributor clicks on a displayed advertisement and provides a response to a crowdsourcing exercise.

In some implementations, the contribution engine may calculate a value for the contributor to be reported to the advertising engine with the conversion event. The value may be a total information gain for the contributor based on the response (245). The total information gain is a measure of the total information “transmitted” by the contributor, with each contributor being treated as a “noisy channel.” The total information gain may be derived from an information gain calculated for each answer multiplied by the total number of answers provided by the contributor. More formally, information gain (IG) for a particular question may be defined by the following

IG(q,n)=H(1/n,n)−H(q.n)

where q is the probability that the contributor provides a correct response for a randomly chosen question with n options as multiple choices for the answer. When q is 1, the user always gives correct answers. H(q,n) defines the entropy for an answer. When q is 1 the entropy is zero, meaning there is no uncertainty. If the contributor selects an answer at random from the n choices, then q is 1/n and the entropy is log(n). The quality (e.g., q) of a response to the contribution exercise from a contributor is unknown. While an estimate of q can be determined by dividing the number of correct past responses by the total number of past responses, this ratio does not work well with only a few prior responses.

To deal with the uncertainty in measuring the quality of each contributor, the contribution engine may use a Bayesian version of the information gain metric. Specifically, the contribution engine may treat the estimate of q as a distribution and not a point estimate. The expected information gain when q is a random variable may be expressed by the formula

E[IG(q,n)]=∫_{q=0}¹Pr(q)·IG(q,n)dq

The contribution engine may assume q is constant across questions and latent. When q is assumed constant the number of correct responses from a contributor follows a binomial distribution, allowing the contribution engine to use a Bayesian estimation strategy for estimating the probability of success q in a binomial distribution. Thus, after the contributor submits a correct responses and b incorrect responses, Pr(q) may be expressed by

$$Pr ( q ) = {q}^{a} \cdot {( 1 - q )}^{b} \frac{1}{B ( a + 1 , b + 1 )}$$

with B(x,y) being the Beta function. The contribution engine may calculate the expected information gain for the current contribution and, in some implementations, may update a contributor profile to reflect the information gain.

The contribution engine may notify the advertising platform that a conversion event occurred for the contributor and, in some implementations, provide a value that quantifies the conversion event (250). In some implementations, the contribution engine may provide the feedback only when the value exceeds a threshold. This feedback may be used by the advertising platform to optimize the advertising campaign (255). For example, the advertising platform may use characteristics of the contributor to find similar potential contributors to target with the advertisements. Of course, if the value provided with the conversion event information is small, the advertising platform may use the information to determine which potential contributors are not desired. The contribution engine may continue to provide contribution exercises (260, No) until the contributor chooses to leave the crowdsource exercise (260, Yes). Process 200 illustrates how the feedback is a loop that informs the advertising platform which contributors are valuable, which helps the advertising platform to target potential contributors. The use of the feedback loop can result in 9 times more conversion events and higher quality contributions. In some implementations, the information gain for responses is ten times higher than without the feedback.

It is understood that the use of the advertising campaign may be used to target potential contributors with specific knowledge. Thus, for example, the example advertisement 300 of FIG. 3 may be used to attract contributors with medical or scientific knowledge. The subject of the ad may be used in addition to keywords etc. Of course, a different ad may be used to target those with other areas of expertise or interest.

Predicting Contribution Quality

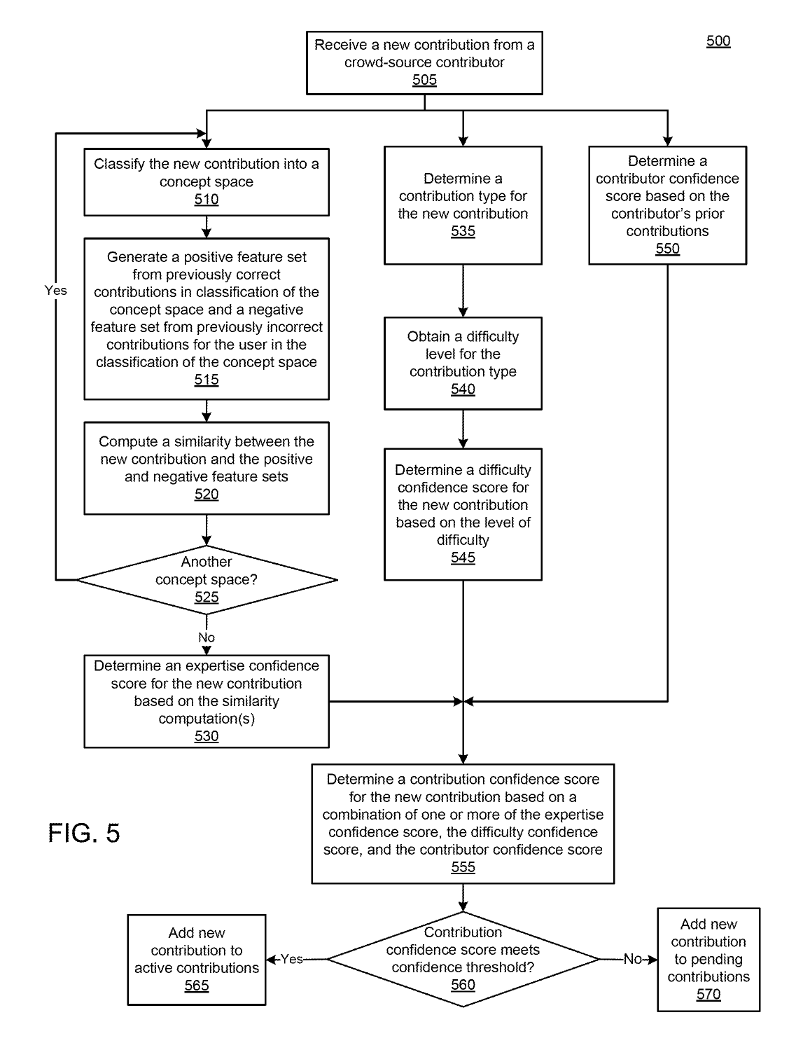

FIG. 5 illustrates a flow diagram of an example process 500 for predicting the quality a contribution, in accordance with an implementation. Process 500 may be performed by a contribution targeting system, such as contribution engine 110 of FIG. 1. Process 500 evaluates several signals to predict the quality of a contribution. In some implementations, process 500 may also be used in process 200, for example as an additional step after receiving the response (240). For example, if the crowdsourcing exercise was a collection question rather than a calibration question, the system may predict the quality of the collection response, i.e., the new contribution, to determine if the new contribution can be added automatically to active contributions.

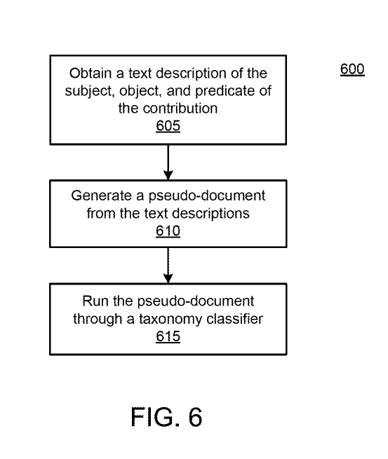

Accordingly, process 500 begins with the receipt of a new contribution from a crowdsource contributor (505). The system may proceed to evaluate various signals for the new contribution. One of the signals may be a contributor expertise signal, expressed as an expertise confidence score. In other words, for the particular contributor, the system may determine what area of expertise the contribution falls under and then estimate the contributor's expertise in that area based on prior contributions in the area. The area of expertise may itself be based on classification in one or more concept spaces. Thus, the system may determine a classification for the contribution in a concept space (510). A concept space is a topic, a taxonomy, and/or a contribution type. A topic concept space may be derived from a topic model trained in an unsupervised manner using a large corpus, such as a web corpus. The topic model can then be used to classify a new contribution into one of the topics. If the new contribution is not a text-based contribution, the system may generate a pseudo-document from the contribution, as described hereafter with regard to FIG. 6, and use the topic model to classify the pseudo-document into a topic.

A taxonomy concept space may be based on a hierarchical taxonomy. The new contribution may be classified into one or more nodes of the hierarchy by a hierarchical text classifier, as described above with regard to taxonomy 150 of FIG. 1. As with the topic concept space, if a new contribution is not text-based, the system may generate the pseudo-document and use the hierarchical text classifier on the pseudo-document to determine the classification of the contribution within the taxonomy. In some implementations, the taxonomy concept space may also be based on non-hierarchical topic models, such as a list of topics.

A contribution type concept space may be based on attributes of the crowdsourced repository itself. For example, in a crowdsourced knowledge base, a contribution includes a subject-predicate-object triple. The classification of the contribution may be based directly on the type of predicate in the triple. For example, a predicate may be “has artist” for an album. Thus, the triple may be <“20/20”, “has artist”, “George Benson”>. In this example, the type of the contribution may be “has artist.” As another example, the type of the contribution may be based on a more general classification of the predicate. For example, “album” or even “music” may be a contribution type for the “has artist” predicate because the “has artist” predicate is categorized as an album attribute in the music domain. In another example, a translation crowdsourced repository may categorize a contribution as a part of speech and use the part of speech as a contribution type, for example, “noun,” “verb,” “adjective,” or even “irregular verb,” or “transitive verb,” etc. Accordingly, the contribution type may be based on how contributions are organized in the crowdsourced repository. The examples discussed above for determining the type of a contribution are for purposes of illustration, and it is understood that other methods of determining a type of a contribution may be used.

Once the new contribution is classified within the concept space, the system may generate a positive feature set and a negative feature set from prior contributions for the contributor that share the same classification in the concept space (515). In some implementations, as contributions are received, they are classified and stored with an indication of the classification and the contributor. In such an implementation, the system may search the repository for contributions from the contributor with the same classification and concept space as the new contribution. If the prior contribution is in the active contributions, it may be considered a positive or correct contribution and included in the positive set. If the prior contribution is in the deleted contributions, it may be considered an incorrect contribution and included in the negative set. In some implementations, the system may also generate a net set, which aggregates all contributions and is computed as the difference of the corresponding features in the positive and negative feature set. In some implementations, prior contributions in the pending set may be ignored. The system may then compute a similarity between the new contribution and the previously contributed correct and incorrect contributions. The similarity may be computed using a dot product similarity metric, a cosine similarity metric, a number of interesting concepts metric, a Jaccard index metric, etc. The dot product and cosine similarity metrics may be run on the positive, negative, and net feature sets, while the Jaccard Index metric and the number of intersecting concepts may be run using just the positive and negative feature sets.

In some implementations, more than one concept space may be used to determine an expertise confidence score for the new contribution. For example, the system may compute a similarity using a contribution type concept space and a taxonomy concept space. Thus, the system may repeat (525, Yes) the classification of the new contribution into the next concept space, generating the feature sets, and computing a similarity for the next concept space. Although shown as a loop in FIG. 5, the system may perform steps 510 through 520 for each concept space concurrently.

When a similarity has been computed for each concept space (525, No), the system may determine an expertise confidence score based on the similarity computation(s) (530). In some implementations, the system may include a machine learning classifier trained to combine the similarity scores of two or more concept spaces to determine the expertise confidence score. The machine learning classifier may be trained with training data and may use the training data to autotune the combination of the similarity computations so that the combination provides the best results for the expertise confidence score. If the new contribution is more similar to previous incorrect contributions, the system may determine that the expertise confidence score is low for the new contribution. If the new contribution is more similar to previous correct contributions, the system may assign a high expertise confidence score for the new contribution.

Another of the signals may be a contribution feature signal, expressed as a difficulty confidence score. In other words, the system may use historical information about all contributions of a similar type as the new contribution as a predictor of how likely it is that the new contribution is correct. For example, contributions for one subject area may historically be mostly correct across all contributors, while contributions for another subject area may have been mostly deleted. If contributions of a particular type are often deleted, regardless of who the contributor is, the system may predict that the subject area, or contribution type, is difficult and a new contribution in that area is not likely correct. The system may accordingly determine the contribution type or the subject area for the new contribution (535). The system may have done this already if the system has used the contribution type concept space in the calculation of an expertise confidence score (e.g., step 510). In some implementations, the calculation of the difficulty confidence score may be performed concurrently with the calculation of the expertise confidence score, and the system may remember and re-use the determination of the contribution type.

The system may then obtain a difficulty level for the contribution type of the new contribution (540). The difficulty level may be stored in a type profile, such as the profile 142 of FIG. 1. The system may generate the type profile periodically based on the active and deleted contributions. The system may also update the type profile on an on-going basis, for example as contributions are added to the active contributions and/or deleted contributions. The system may use the difficulty level for the contribution type to determine a difficulty confidence score for the new contribution (545). For example, if a high percentage of contributions for the contribution type are deleted, the difficulty level may be the percentage and the difficulty confidence score may be low, e.g., an inverse of the difficult level, so that very high difficulty levels result in very low difficulty confidence scores in either process.

Another of the signals may be a contribution history score for the contributor, expressed as a contributor confidence score. In other words, the system may use historical information about all of the contributor's past contributions to characterize the number and the correctness rate of the user's prior contributions. In some implementations, the system may determine a contributor confidence score using several features for prior contributions (550). Table 1 below illustrates example features that can be used to determine the contributor confidence score:

TABLE 1

| Feature Description | Scaling |
|---|---|
| Total number of prior contributions | log |
| Total number of prior correct contributions | log |
| Total number of prior incorrect contributions | log |
| Fraction of correct contributions | |
| Total number of possibly incorrect contributions | log |
| Fraction of possibly incorrect contributions | |
| Total number of prior deletion actions | log |
| Number of bad (reverted) deletion actions | |
| Fraction of bad deletions | |
| Membership lifetime of contributor (in days) | |
| Number of seconds since last contributor action | log |

The system may use a machine learning classifier trained to determine the contributor confidence score, based on the features of Table 1.

The system may then combine the various signals to determine a contribution confidence score for the new contribution (555). The contribution confidence score may be based on one signal, such as the expertise confidence score or the difficulty confidence score, but it can be more accurate when based on a combination of signals. To combine the signals, in some implementations, the system may use the machine learning classifier to predict the contribution score. The machine learning classifier may be a linear or a nonlinear classifier that weights each signal given appropriately to produce the best prediction result for a training set. In some implementations, the signals may also be averaged, added, or combined in some other manner.

The system may use the contribution confidence score to determine whether to automatically add the new contribution to active contributions or not. For example, the system may compare the contribution confidence score to a threshold (560). If the confidence score meets the threshold (560, Yes), the system may automatically add the new contribution to the active contributions (565) so that it may be made available without further verification and without restrictions (such as a flag indicating the contribution has not been verified). If the contribution confidence score does not meet the threshold (560, No), the system may add the new contribution to pending contributions that need additional verification (570). The additional verification may be accomplished through manual verification or by a test-of-time verification etc. Process 500 then ends, having predicted the quality of the new contribution based on a variety of signals.

FIG. 6 illustrates an example of a process for determining the classification of a contribution, according to an implementation. Some contributions may not be text-based, for example when a contribution represents entities in a knowledge graph linked by a relationship, e.g., a subject-predicate-object triple. Such a contribution may be represented by entity and relationship identifiers, which are not able to be classified by a text classifier. Accordingly, the system may obtain a text description of the subject, object, and predicate of the contribution (605). The text description may be stored as an attribute of the entity that is identified as the subject or object, for example. The predicate may also have a text description as an attribute. The system may generate a pseudo-document from the text descriptions (610). In some implementations the system may concatenate the text descriptions or may put each text description in a separate paragraph in the document. The system may run the generated pseudo document through the taxonomy classifier to determine a node or nodes for the new contribution (615).

FIG. 7 shows an example of a generic computer device 700, which may be operated as system 100, and/or client 180 of FIG. 1, which may be used with the techniques described here. Computing device 700 is intended to represent various example forms of computing devices, such as laptops, desktops, workstations, personal digital assistants, cellular telephones, smart phones, tablets, servers, and other computing devices, including wearable devices. The components shown here, their connections and relationships, and their functions, are meant to be examples only, and are not meant to limit implementations of the inventions described and/or claimed in this document.

Computing device 700 includes a processor 702, e.g., a silicone-based hardware processor, memory 704, a storage device 706, and expansion ports 710 connected via an interface 708. In some implementations, computing device 700 may include transceiver 746, communication interface 744, and a GPS (Global Positioning System) receiver module 748, among other components, connected via interface 708. Device 700 may communicate wirelessly through communication interface 744, which may include digital signal processing circuitry where necessary. Each of the components 702, 704, 706, 708, 710, 740, 744, 746, and 748 may be mounted on a common motherboard or in other manners as appropriate.

The processor 702 can process instructions for execution within the computing device 700, including instructions stored in the memory 704 or on the storage device 706 to display graphical information for a GUI on an external input/output device, such as display 716. Display 716 may be a monitor or a flat touchscreen display. In some implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk. In some implementations, the memory 704 may include expansion memory provided through an expansion interface.

The storage device 706 is capable of providing mass storage for the computing device 700. In one implementation, the storage device 706 may be or include a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in such a computer-readable medium. The computer program product may also include instructions that, when executed, perform one or more methods, such as those described above. The computer- or machine-readable medium is a storage device such as the memory 704, the storage device 706, or memory on processor 702.

The interface 708 may be a high speed controller that manages bandwidth-intensive operations for the computing device 700 or a low speed controller that manages lower bandwidth-intensive operations, or a combination of such controllers. An external interface 740 may be provided so as to enable near area communication of device 700 with other devices. In some implementations, controller 708 may be coupled to storage device 706 and expansion port 714. The expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 730, or multiple times in a group of such servers. It may also be implemented as part of a rack server system. In addition, it may be implemented in a personal computer such as a laptop computer 722, or smart phone 736. An entire system may be made up of multiple computing devices 700 communicating with each other. Other configurations are possible.

FIG. 8 shows an example of a generic computer device 800, which may be system 100 of FIG. 1, which may be used with the techniques described here. Computing device 800 is intended to represent various example forms of large-scale data processing devices, such as servers, blade servers, datacenters, mainframes, and other large-scale computing devices. Computing device 800 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Distributed computing system 800 may include any number of computing devices 880. Computing devices 880 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 880a includes multiple racks 858a-858n. Each rack may include one or more processors, such as processors 852a-852n and 862a-862n. The processors may include data processors, network attached storage devices, and other computer controlled devices. In some implementations, one processor may operate as a master processor and control the scheduling and data distribution tasks. Processors may be interconnected through one or more rack switches 858, and one or more racks may be connected through switch 878. Switch 878 may handle communications between multiple connected computing devices 800.

Each rack may include memory, such as memory 854 and memory 864, and storage, such as 856 and 866. Storage 856 and 866 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 856 or 866 may be shared between multiple processors, multiple racks, or multiple computing devices and may include a computer-readable medium storing instructions executable by one or more of the processors. Memory 854 and 864 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 854 may also be shared between processors 852a-852n. Data structures, such as an index, may be stored, for example, across storage 856 and memory 854. Computing device 800 may include other components not shown, such as controllers, buses, input/output devices, communications modules, etc.

An entire system, such as system 100, may be made up of multiple computing devices 800 communicating with each other. For example, device 880a may communicate with devices 880b, 880c, and 880d, and these may collectively be known as system 100. As another example, system 100 of FIG. 1 may include one or more computing devices 800. Some of the computing devices may be located geographically close to each other, and others may be located geographically distant. The layout of system 800 is an example only and the system may take on other layouts or configurations.

Various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any non-transitory computer program product, apparatus and/or device (e.g., magnetic discs, optical disks, memory (including Read Access Memory), Programmable Logic Devices (PLDs)) used to provide machine instructions and/or data to a programmable processor.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer system comprising:
at least one processor; and
memory storing instructions that, when executed by the at least one processor, cause the system to:
determine a concept space for a new contribution from a contributor to a crowdsourced repository;
obtain previously correct contributions of the contributor in the concept space;
obtain previously incorrect contributions of the contributor in the concept space;
determine an expertise confidence score for the new contribution based on a comparison of the new contribution with the previously correct contributions and the previously incorrect contributions; and
automatically approve the new contribution for the crowdsourced repository based on whether a threshold is met based on the expertise confidence score.

2. The system of claim 1 wherein the memory further stores instructions that, when executed by the at least one processor, cause the system to:
determine a type of the new contribution;
determine a level of difficulty assigned to the type; and
determine a difficulty confidence score based on the level of difficulty,
wherein automatically approving the new contribution is based on whether the threshold is met based on a combination of the difficulty confidence score and the expertise confidence score.

3. The system of claim 1, wherein the concept space is a topic in a taxonomy of commercial topics.

4. The system of claim 3, wherein the crowdsourced repository is a knowledge base and the new contribution is a triple for the knowledge base, and the concept space is determined by:
obtaining a text equivalent for each element of the triple;
generating a pseudo document from the text equivalents; and
classifying the pseudo document into the taxonomy.

5. The system of claim 3, wherein the expertise confidence score is a first expertise confidence score and the memory further stores instructions that, when executed by the at least one processor, cause the system to:
determine a second concept space for the new contribution;
obtain previously correct contributions of the contributor in the second concept space;
obtain previously incorrect contributions of the contributor in the second concept space; and
determine a second expertise confidence score for the new contribution based on a comparison of the new contribution with the previously correct contributions for the second concept space and with the previously incorrect contributions for the second concept space; and
wherein automatically approving the new contribution is based on whether the threshold is met based on a combination of the first expertise score and the second expertise score.

6. The system of claim 5, wherein the second concept space is a type of the new contribution.

7. The system of claim 1, wherein the concept space is a type of the new contribution.

8. The system of claim 7, wherein the crowdsourced repository is a knowledge base and the new contribution is a triple that includes a subject, a predicate, and an object and the concept space is determined by the predicate.

9. The system of claim 1, wherein comparing the new contribution with the previously correct contributions and the previously incorrect contributions is based on one or more of a dot product, a cosine similarity, a number of intersecting concepts, and a Jaccard Index.

10. The system of claim 1, further comprising, in response to the new contribution being automatically approved, adding the new contribution to the previously correct contributions of the contributor.

11. A method comprising:
determining, using at least one processor formed in a substrate, a contribution type for a new contribution from a contributor to a crowdsourced repository,
obtaining a first positive feature set of prior correct contributions from the contributor for the contribution type;
obtaining a first negative feature set of prior incorrect contributions from the contributor for the contribution type;
determining, using the at least one processor, a first expertise confidence score for the new contribution based on a comparison of the new contribution with the first positive feature set and the first negative feature set;
determining a taxonomy classification for the new contribution;
obtaining a second positive feature set of prior correct contributions from the contributor for the taxonomy classification;
obtaining a second negative feature set of prior incorrect contributions from the contributor for the taxonomy classification;
determining, using the at least one processor, a second expertise confidence score for the new contribution based on a comparison of the new contribution with the second positive feature set and with the second negative feature set;
determining a contribution confidence score based on a combination of the first expertise confidence score and the second expertise confidence score; and
automatically adding the new contribution to active contributions for the crowdsourced repository based on whether the contribution confidence score meets a threshold.

12. The method of claim 11, wherein the crowdsourced repository is a knowledge base and the new contribution is a triple for the knowledge base, and determining the taxonomy classification includes:
obtaining a text equivalent for each element of the triple;
generating a pseudo document from the text equivalents; and
classifying the pseudo document into the taxonomy.

13. The method of claim 11, further comprising:
determining a contributor confidence score based on prior contributions by the contributor; and
determining the contribution confidence score based on a combination of the contributor confidence score, the first expertise confidence score and the second expertise confidence score.

14. The method of claim 11, further comprising:
determining a type of the new contribution;
determining a level of difficulty assigned to the type;
determining a difficulty confidence score based on the level of difficulty, and
determining the contribution confidence score based on a combination of the difficulty confidence score, the first expertise confidence score and the second expertise confidence score.

15. The method of claim 14, wherein the type is based on an organizational structure of the crowdsourced repository.

16. A method comprising:
providing information to an advertising platform, the advertising platform using the information to determine potential contributors for a crowdsourced repository and to display an advertisement to the potential contributors;
receiving, using at least one processor formed in a substrate, an indication that a contributor of the potential contributors responded to the advertisement;
generating, using the at least one processor, a crowdsourcing exercise that is presented to the contributor;
determining that a conversion event occurred for the contributor in response to receiving a response from the contributor to the crowdsourcing exercise; and
notifying the advertising platform that the conversion event occurred for the contributor.

17. The method of claim 16, further comprising:
calculating a value for the conversion event based on one or more responses to the crowdsourcing exercise from the contributor; and
providing the value to the advertising platform with the notification, the advertising platform using the value to refine the determining of potential contributors.

18. The method of claim 17, the crowdsourcing exercise having a question format, where the question is either a collection question or a calibration question.

19. The method of claim 18, the method further comprising:
repeating the generating and receiving, thereby collecting a quantity of responses for the contributor; and
storing the responses for the contributor and whether a particular response was a collection or a calibration question.

20. The method of claim 19, the value being based on an information gain for a most recent response from the contributor multiplied by the quantity of responses.

21. The method of claim 20, wherein the information gain is based on calculating a probability of a correct response in a binomial distribution, a quantity of correct responses, and a quantity of incorrect responses.

22. The method of claim 17, wherein the value is provided to the advertising platform when the value meets a threshold.
